(19) United States
(12) Patent Application Publication
(10) Pub. No.: US 2005/0240699 A1
(43) Pub. Date: Oct. 27, 2005

(54) Safe process deactivation

(76) Inventors: Michael E. Yoder, San Jose, CA (US); William N. Pohl, Morgan Hill, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/813,879

(22) Filed: Mar. 31, 2004

(51) Int. Cl. G06F 12/00

(52) U.S. Cl. 710/200

(57) ABSTRACT

One embodiment disclosed relates to a method of deactivating a process by a computer operating system. Threads of the process that are currently suspendable are moved to a stopped state. A process-wide deactivation operation is initiated. The process-wide deactivation operation is called by outstanding threads of the process when the outstanding threads re-enter the operating system's kernel.

### BACKGROUND OF THE INVENTION

1. Field of the Invention

The present invention relates generally to computer operating systems. More specifically, the present invention relates to the management of multi-threaded computer processes.

2. Description of the Background Art

The basic structure of a conventional computer system includes one or more processors which are connected to several input/output (I/O) devices for the user interface (such as a display monitor, keyboard and mouse), a permanent memory device for storing the computer's operating system and user programs (such as a magnetic hard disk), and a temporary memory device that is used by the processors to carry out program instructions (such as random access memory or RAM). The processors communicate with the other devices by various means, including a system bus or a direct channel.

When a user program runs on a computer, the computer's operating system (OS) first loads the main program file into system memory. The program file includes several objects (values) stored as data or text, and instructions for handling the data and other parameters which may be input during program execution. The processors use “logical addresses” to access the file objects, and these logical addresses correspond to physical addresses in RAM. Binding of instructions and data to physical memory addresses may be accomplished by compiling the program file using relocatable code, which is indexed (linked) to physical memory by the OS loader during loading of the file.

Computer programs can be broken down into a collection of processes which are executed by the processor(s). A process is a set of resources, including (but not limited to) logical addresses, process limits, permissions and registers, and at least one execution stream. The smallest unit of operation to be performed within a process is referred to as a thread. The use of threads in modern operating systems is well known. Threads allow multiple execution paths within a single address space (the process context) to run concurrently on a processor. This “multithreading” increases throughput in a multiprocessor system and provides modularity in a uniprocessor system.

### SUMMARY

One embodiment of the invention relates to a method of deactivating a process by a computer operating system. Threads of the process that are currently suspendable are moved to a stopped state. A process-wide deactivation operation is initiated. The process-wide deactivation operation is called by outstanding threads of the process when the outstanding threads re-enter the operating system's kernel.

### BRIEF DESCRIPTION OF THE DRAWINGS

FIG. 1 is a schematic diagram of a previous method of deactivating processes in a multithreaded operating system

FIGS. 2A and 2B are flow charts depicting a method of safely deactivating a multi-threaded process in accordance with an embodiment of the invention.

FIG. 3 is a flow chart depicting a method of dealing with re-entering threads of a self-deactivating process in accordance with an embodiment of the invention.

FIG. 4 is a flow chart depicting a method of dealing with threads that are going to sleep for memory in accordance with an embodiment of the invention.

FIG. 5 is a flow chart depicting a method of reactivating a deactivated process in accordance with an embodiment of the invention.

### DETAILED DESCRIPTION

The following discussion describes one or more embodiments of the invention. In the interest of clarity, not all features of an actual implementation are described in this specification. It will be appreciated that, in the development of any such actual embodiment, numerous implementation-specific decisions must be made to achieve the developers' specific goals. Such details might include compliance with system-related and business-related constraints, which will vary from one implementation to another, for instance. Moreover, it will be appreciated that such a development effort, even if complex and time-consuming, would be a routine undertaking for those of ordinary skill in the art having the benefit of this disclosure.

Process deactivation is a mechanism by which a process' threads are forcibly stopped and that process' memory pages are marked to be pushed out from more rapidly accessible semiconductor memory to more slowly accessible disk memory. Processes are deactivated in order to free up resources on a heavily loaded system. For example, processes may be deactivated when the system is thrashing or under severe memory pressure. Deactivating a process frees up resources by: a) allowing reserved memory areas (for example, one user structure or UAREA per thread) of the process to be pushed out to disk by the virtual memory handler; b) stopping that process from running or attempting to run; and c) stopping the process from generating input/output traffic due to page faults. This allows more deserving (non-deactivated) processes to use the freed-up resources to complete their tasks.

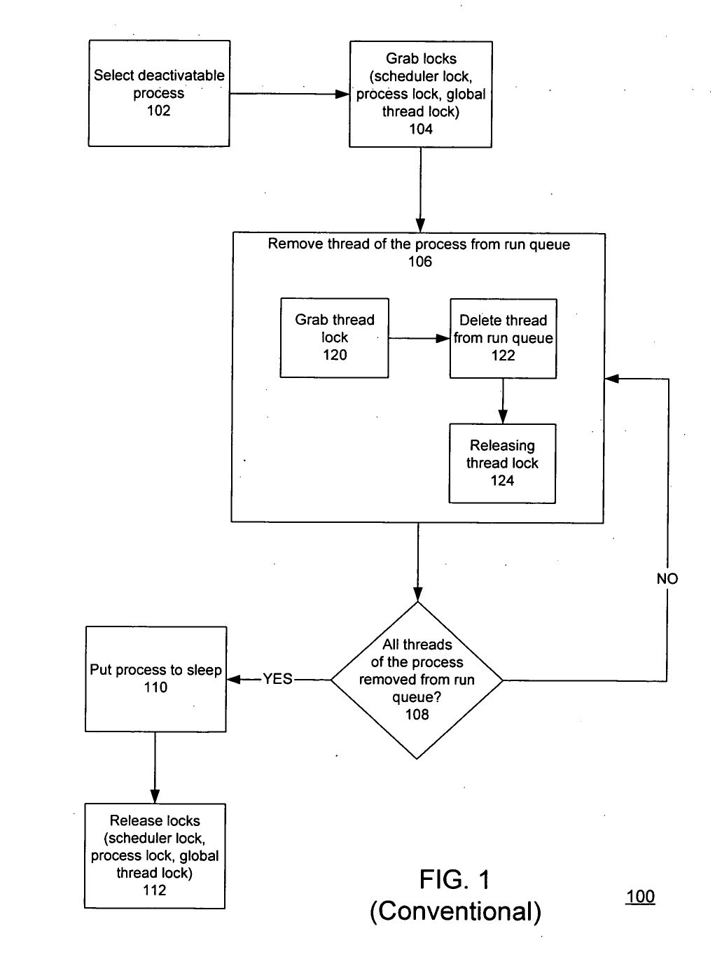

A previous method 100 of deactivating processes in a multithreaded operating system is depicted in FIG. 1. In this method 100, after determining 102 that a process is to be deactivated, the system grabs 104 locks on necessary kernel resources. These locks held include the scheduler locks, the process lock, and the global thread lock. The system then removes (in other words, “yanks”) 106 the threads of the process from the run queue until all the threads of that process are no longer running 108. Removal 106 of each thread involves grabbing 122 a lock on the thread, deleting 124 that thread, and releasing 126 the thread lock. Then, the process is put to sleep 110, and the held locks (for example, the scheduler, process, and global thread locks) are released 112.

Unfortunately, the above-discussed method 100, although utilizing four locks, has potential flaws when put to practice. For example, a thread lock may, in some systems, lock only the outgoing thread (the thread just run) and not the thread that's about to run. In such a case, a thread may “sneak” back onto a processor during the process of its removal from the run queue. If this happened, threads could be “deactivated” while still holding kernel resources, and such behavior may result in system hangs. As another example, during reactivation, a newly reactivated thread could cause other, not yet reactivated threads to begin running before they were “officially” reactivated. If this happened, it would lead to an incorrect thread state. The above-discussed method 100 is also disadvantageous in that a relatively large amount of code is forced to be aware of deactivation states.

An improved method of safely deactivating multi-threaded processes is described herein. This method avoids the potential flaws and disadvantages in the above-discussed previous method 100. This method has an advantage of code separation between different kernel subsystems.

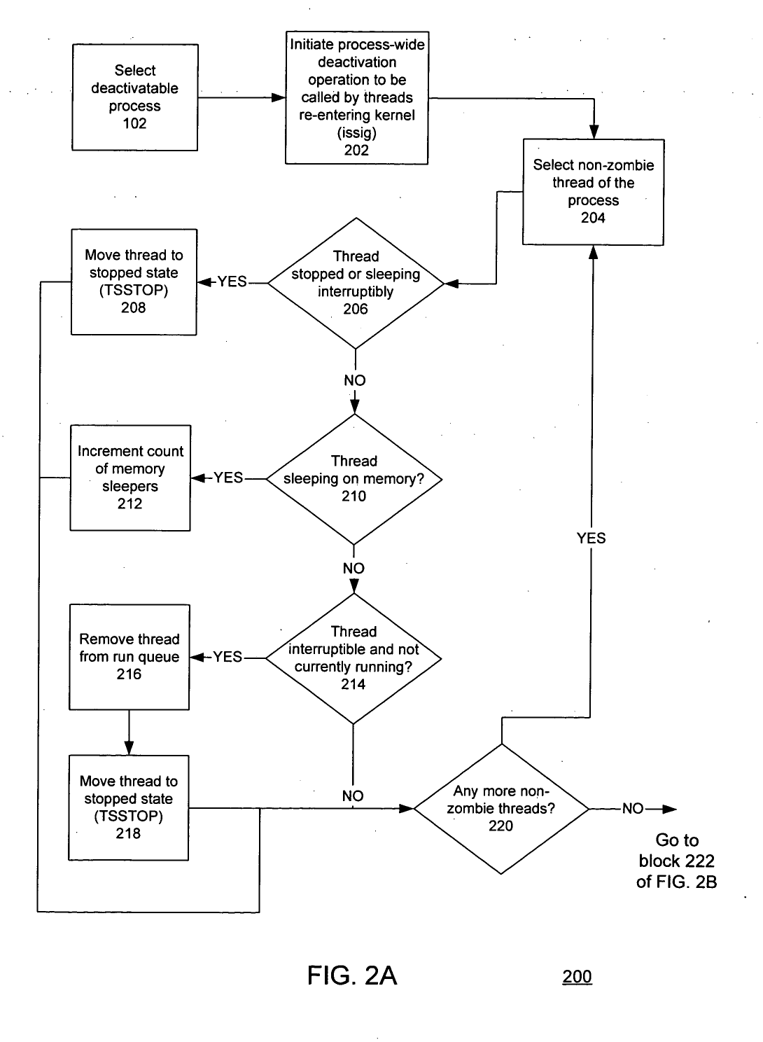

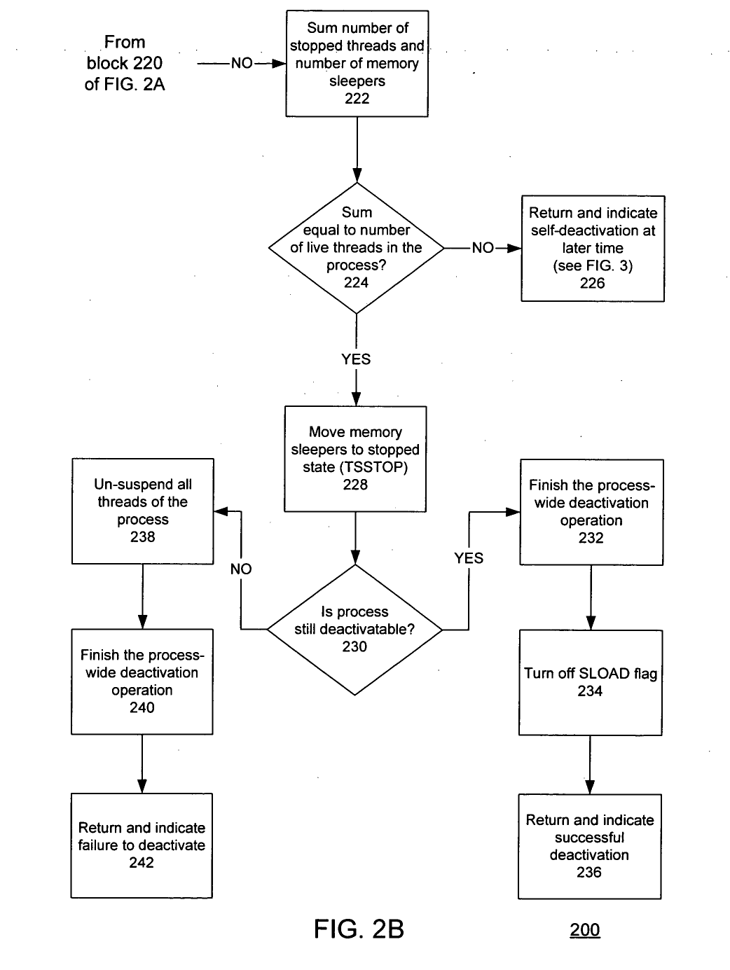

FIGS. 2A and 2B are flow charts depicting a method 200 of safely deactivating a multi-threaded process in accordance with an embodiment of the invention. This method 200 includes a new procedure for stopping a process' threads in preparation of deactivation.

As in the conventional procedure 100 of FIG. 1, if there is severe memory pressure or the system is thrashing, the memory swapper will select 102 a process to be deactivated (to relieve the memory pressure). However, thereafter, this method 200 differs from the conventional procedure 100.

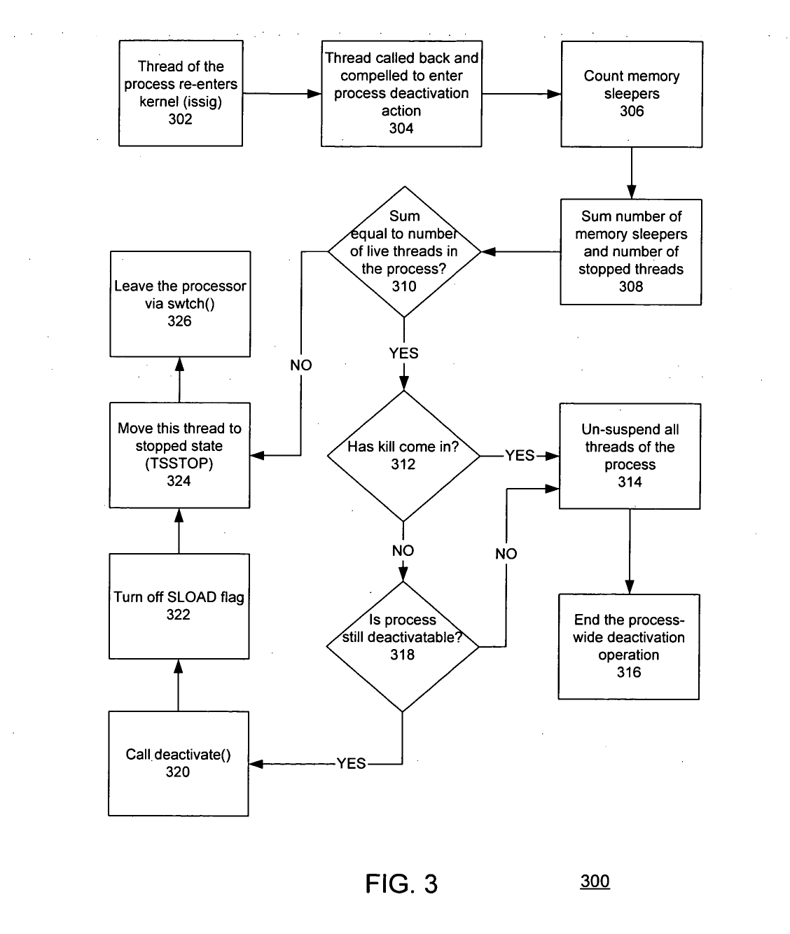

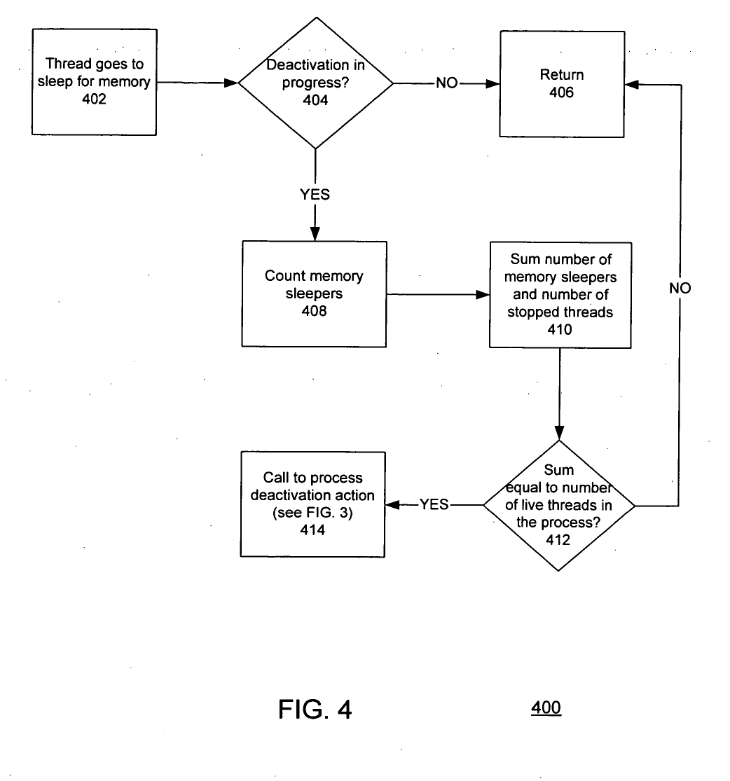

In response to the selection 102 of the process for deactivation, the swapper initiates 202 a process-wide deactivation operation, which may be named P_OP_DEACT, using a process deactivation action callback function, which may be named process_deact_action(). This callback function is to be called by threads re-entering issig(), i.e. re-entering the kernel, as discussed further below in relation to FIG. 3.

Then, the method 200 performed by the swapper proceeds as follows for all non-zombie threads. Each non-zombie thread of the process to be deactivated is selected 204, and a determination 206 is made as to whether that thread is currently stopped or sleeping interruptibly (i.e. at a “suspension point”). If so, then the thread is moved 208 to a stopped state (which may be called TSSTOP). If not, then a further determination 210 is made as to whether the thread is sleeping on memory. In other words, whether the thread is a memory sleeper. A memory sleeper is a thread that is sleeping due to the system being too low on memory. If the thread is a memory sleeper, then a count of memory sleepers is incremented 212. Otherwise, a further determination 214 is made as to whether the thread is interruptible and not currently running. If so, then the thread is removed 216 from the run queue and moved 218 to the stopped state (TSSTOP). As long as the swapper determines 220 that there are more non-zombie threads of the process being deactivated. When all non-zombie threads of the process have been gone through, then the swapper continues with the step 222 shown in FIG. 2B.

In that step 222, the number of stopped threads is summed 222 with the number of memory sleepers. A determination 224 is then made as to whether that sum is equal to the number of live threads in the process being deactivated. If they are not equal, then that means there are threads still remaining to be stopped. In that case, the procedure returns 226 with an indication that self-deactivation of the process is set to occur at a later time (after the remaining threads re-enter the kernel). If they are equal, then that means there are no more threads remaining to be stopped. In that case, the memory sleeping threads are moved 228 to the stopped state (TSSTOP), and a further determination 230 is made as to whether the process is still considered by the swapper to be deactivatable. If the process is still deactivatable, then, in accordance with one embodiment, the process-wide deactivation operation is finished 232, the SLOAD flag is turned off 234 to implement deactivation of the process, and the procedure returns 236 with an indication that deactivation was successful (immediately). Otherwise, if the process is no longer deactivatable, then all the process' threads that have been suspended are un-suspended 238, the process-wide deactivation operation is finished 240, and the procedure returns 242 with an indication of a failure to deactivate the process.

FIG. 3 is a flow chart depicting a method 300 of dealing with re-entering threads of a self-deactivating process (i.e. a process with a pending deactivation request) in accordance with an embodiment of the invention. When a thread of the self-deactivating process re-enters 302 issig(), i.e. re-enters the kernel, then that thread is called back and compelled to enter 304 the process deactivation action function, process_deact_action(). This function counts (or determines the count of) 306 the threads that are memory sleepers, and sums 308 the number of memory sleepers and the number of stopped threads (including the current thread in the count of stopped threads although it is not yet stopped). That sum is compared 310 to the number of live threads in the process. If they are not equal, then there remains more outstanding threads, so the function simply moves 324 this thread (the thread that was called back 304) to the stopped state (TSSTOP), and leaves 326 the processor via the swtch() function. On the other hand, if they are equal, then no more outstanding threads remain, so the function goes on to determine 312 whether a kill command for that process has come in. If a kill has been received, then all the process' threads that have been suspended are un-suspended 314, and the process-wide deactivation operation is ended 316. This is because the process is to be killed so that the deactivation is rendered to be no longer pertinent. Otherwise, if no kill has been received, then a further determination 318 is made as to whether the process is still deactivatable. If the process is no longer deactivatable, then all the process' threads that have been suspended are un-suspended 314, and the process-wide deactivation operation is ended 316. If the process is still deactivatable, then a deactivate function, deactivate(), is called 320. In one embodiment, this function may be configured to turn off 322 the SLOAD flag to implement deactivation of the process, move 324 this thread to the stopped state (TSSTOP), and leave 326 the processor via the swtch() function.

FIG. 4 is a flow chart depicting a method 400 of dealing with threads that are going to sleep for memory in accordance with an embodiment of the invention. When such a thread goes to sleep 402 for memory, then a new function is called. This new function checks 404 to see if there is a deactivation in progress. In other words, a check is made as to whether the process for that thread is self-deactivating. If there is no deactivation in progress, then the function simply returns 406. On the other hand, if there is a deactivation in progress, then this function counts (or determines the count of) 408 the threads of the process that are memory sleepers, and sums the number of memory sleepers and the number of stopped threads of the process 410. That sum is compared 412 to the number of live threads in the process. If they are not equal, then the function simply returns. On the other hand, if they are equal, then the function may be configured to perform a call 414 to the process deactivation action function, process_deact_action(), which is discussed above in relation to FIG. 3.

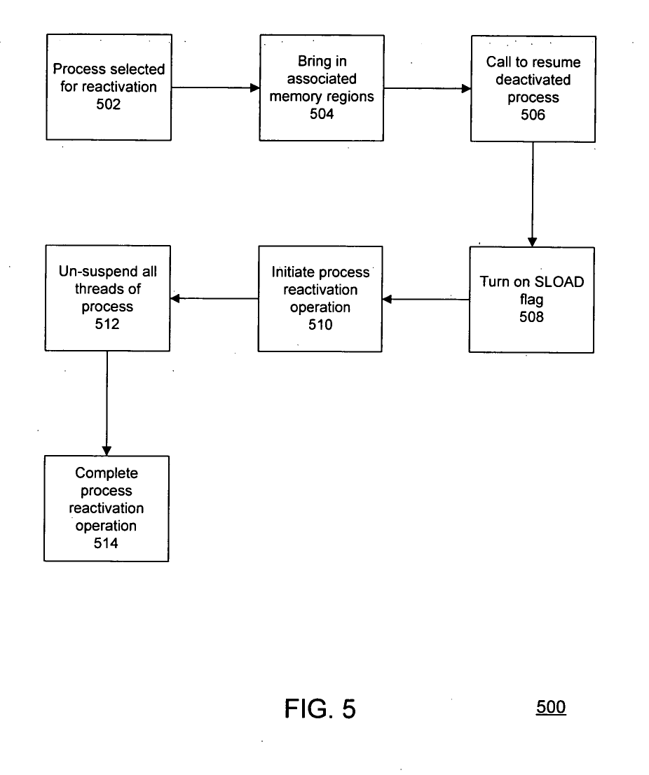

FIG. 5 is a flow chart depicting a method 500 of reactivating a deactivated process in accordance with an embodiment of the invention. The swapper selects 502 the deactivated process for reactivation. The reactivation may be because, for example, increased memory resources are available for that process, or for other reasons. A reactivation routine, reactivate(), may be called. The reactivation routine may bring in 504 memory regions associated with the reactivating process. For example, a message may be sent to instruct the pregions/regions of memory that they are coming back in, and the user structure (UAREA) may be brought in more directly. The reactivation routine may then call 506 a resume deactivated process function, process_deact_resume() to handle the threads. This function may be configured to turn on 508 the SLOAD flag, initiate 510 a process-wide reactivation operation (P_OP_REACT), unsuspend the threads of the reactivating process, and complete the reactivation operation (P_OP_REACT).

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

1. A method of deactivating a process by a computer operating system, the method comprising:
initiating a process-wide deactivation operation;
determining whether threads of the process are currently suspendable; and
moving the threads of the process that are currently suspendable to a stopped state;
wherein the process-wide deactivation operation is called by outstanding threads of the process when the outstanding threads re-enter a kernel of the operating system.

2. The method of claim 1, wherein a thread is currently suspendable if the thread is stopped.

3. The method of claim 2, wherein a thread is also currently suspendable if the thread is sleeping interruptibly.

4. The method of claim 3, wherein a thread is also currently suspendable if the thread is interruptible and not currently running, and wherein the thread is removed from a run queue prior to moving the thread to the stopped state.

5. The method of claim 1, further comprising:
determining whether threads of the process are sleeping on memory; and
counting the threads of the process that are sleeping on memory to determine a number of memory sleepers.

6. The method of claim 5, further comprising:
calculating a sum of a number of threads in the stopped state and the number of memory sleepers.

7. The method of claim 6, further comprising:
determining if the sum is equal to a number of live threads in the process.

8. The method of claim 7, further comprising:
returning and indicating self-deactivation pending if the sum is unequal to the number of live threads.

9. The method of claim 7, further comprising:
moving the threads of the process that are sleeping on memory to the stopped state if the sum is equal to the number of live threads.

10. The method of claim 9, further comprising:.
determining if the process is still deactivatable.

11. The method of claim 10, further comprising, if the process is still deactivatable, then finishing the process-wide deactivation operation and turning off a flag for the process.

12. The method of claim 10, if the process is no longer deactivatable, then un-suspending threads of the process and finishing the process-wide deactivation operation.

13. The method of claim 1, wherein zombie threads are not analyzed.

14. The method of claim 1, wherein the method is performed by code of a memory swapper of the operating system.

15. The method of claim 1, further comprising:
compelling a thread re-entering the kernel to enter the process deactivation operation.

16. The method of claim 15, wherein the process deactivation operation performs steps including:
moving the re-entering thread to the stopped state.

17. The method of claim 16, wherein the steps performed by the process deactivation operation further includes:
counting the threads of the process that are sleeping on memory to determine a number of memory sleepers;
calculating a sum of a number of threads in the stopped state and the number of memory sleepers; and
determining if the sum is equal to a number of live threads in the process.

18. The method of claim 17, wherein if the sum is equal, then the steps performed by the deactivation operation further includes:
un-suspending threads of the process and ending the process-wide deactivation operation if a kill command has been received.

19. The method of claim 17, wherein if the sum is equal, then the steps performed by the deactivation operation further includes:
un-suspending threads of the process and ending the process-wide deactivation operation if the process is no longer deactivatable.

20. The method of claim 17, wherein if the sum is equal, then the steps performed by the deactivation operation further includes, if no kill has been received and the process is still deactivatable, then completing deactivation of the process.

21. The method of claim 1, further comprising:
compelling a thread going to sleep for memory to check whether a deactivation is in progress for the thread's process.

22. The method of claim 1, wherein a deactivated process is reactivated by a procedure that includes bringing in associated memory regions, turning on a flag, and un-suspending threads of the process.

23. A multi-threaded operating system configured to deactivate a multi-threaded process by initiating a process-wide deactivation operation, determining whether threads of the process are currently suspendable, and moving the threads of the process that are currently suspendable to a stopped state, wherein the process-wide deactivation operation is called by outstanding threads of the process when the outstanding threads re-enter a kernel of the operating system's kernel.

24. A computer system having multi-threaded processes, the system comprising:
a process deactivation procedure which initiates a process-wide deactivation operation;
means for determining whether threads of the process are currently suspendable; and
means for moving the threads of the process that are currently suspendable to a stopped state;
wherein the process-wide deactivation operation is called by outstanding threads of the process when the outstanding threads re-enter a kernel of the operating system's kernel.
